(19) United States
(12) Patent Application Publication
(10) Pub. No.: US 2017/0265077 A1
(43) Pub. Date: Sep. 14, 2017

(54) METHOD FOR LOCKING MOBILE TERMINAL AND MOBILE TERMINAL

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Tiancheng TONG, Beijing (CN)

(21) Appl. No.: 15/248,673

(22) Filed: Aug. 26, 2016

Related U.S. Application Data
(63) Continuation of application No. PCT/CN2016/089253, filed on Jul. 7, 2016.

(30) Foreign Application Priority Data
Mar. 14, 2016 (CN) 201610143959.X

(51) Int. Cl. H04W 12/08; H04L 29/06; G06F 21/60; H04W 76/02

(52) U.S. Cl. CPC H04W 12/08; H04W 76/02; H04L 63/06; G06F 21/604

(57) ABSTRACT

An embodiment of the present disclosure discloses a method and a system for locking a mobile terminal, wherein the method is applied to a mobile terminal, comprising: sending a lock state query request to a server each time when the mobile terminal is started, the server storing lock state information of the mobile terminal; comparing the lock state information fed back by the server with the current lock state information of the mobile terminal; and performing a lock operation on the mobile terminal if the lock state information fed back by the server represents a lock state and the current lock state information of the mobile terminal represents a unlocked state. The embodiment of the present disclosure avoids unlocking a mobile terminal through programming ROM, improving security of the mobile terminal.

### CROSS-REFERENCE TO RELATED APPLICATIONS

This application is a continuation of International Application No. PCT/CN2016/089253 filed on Jul. 7, 2016, which is based upon and claims priority to Chinese Patent Application No. 201610143959.X, entitled “METHOD AND SYSTEM FOR LOCKING MOBILE TERMINAL”, filed on Mar. 14, 2016, the entire contents of all of which are incorporated herein by reference.

### TECHNICAL FIELD

The present disclosure generally relates to the technical field of mobile terminals, in particular to a method for locking a mobile terminal and a mobile terminal.

### BACKGROUND

Along with continuous social development and progress, smart mobile phones become more and more popular, and take a more and more important position in life. Among all functions of a smart mobile phone, “seek mobile phone” is absolutely an important and very useful function. If a smart mobile phone is lost, the lost smart mobile phone can be locked by using the “seek mobile phone” function, and then even if other people pick the lost smart mobile phone, the mobile phone cannot be used.

However, the “seek mobile phone” function of common manufacturer has limits, which means that after a smart mobile phone is locked, it can be unlocked by directly programming the ROM image of the manufacturer of the smart mobile phone. By this method, the lock function of the smart mobile phone is skipped over, and then the user of the smart mobile phone loses control over the smart mobile phone.

### SUMMARY

An embodiment of the present disclosure discloses a method and a system for locking a mobile terminal to solve the problem of release lock of a smart mobile phone through programming ROM.

According to an embodiment of the present disclosure, there is provided a method for locking a mobile terminal, applied to a mobile terminal, the method including:

sending a lock state query request to a server each time when the mobile terminal is started, wherein the server stores lock state information of the mobile terminal;

comparing the lock state information fed back by the server with the current lock state information of the mobile terminal;

and performing a lock operation on the mobile terminal if the lock state information fed back by the server represents a lock state and the current lock state information of the mobile terminal represents an unlocked state.

According to an embodiment of the present disclosure, there is provided a mobile terminal includes: at least one processor; and a memory communicably connected with the at least one processor for storing instructions executable by the at least one processor, wherein execution of the instructions by the at least one processor causes the at least one processor to:

send a lock state query request to a server each time when the mobile terminal is started;

compare the lock state information fed back by the server with the current lock state information of the mobile terminal;

perform a lock operation on the mobile terminal if the lock state information fed back by the server represents a lock state and the current lock state information of the mobile terminal represents a unlocked state.

According to an embodiment of the present disclosure, there is provided a computer program, comprising computer readable codes, wherein the computer readable codes run on a mobile terminal so that the mobile terminal executes any one method for locking a mobile terminal above.

According to an embodiment of the present disclosure, there is provided a non-transitory computer readable medium storing executable instructions that, when executed by a mobile terminal, cause the mobile terminal to:

send a lock state query request to a server each time when the mobile terminal is started;

compare the lock state information fed back by the server with the current lock state information of the mobile terminal;

perform a lock operation on the mobile terminal if the lock state information fed back by the server represents a lock state and the current lock state information of the mobile terminal represents a unlocked state.

According to the method and system for locking the mobile terminal provided by the embodiment of the present disclosure, each time when started, the mobile terminal sends the lock state query request to the server which stores the lock state information of the mobile terminal, receives the lock state information fed back by the server, and then compares with the received lock state information with the current lock state information of the mobile terminal. If the received lock state information represents the lock state, the current lock state information of the mobile terminal represents the unlocked status, which means that, when the lock state of the mobile terminal stored in the sever is inconsistent with the current lock state of the mobile terminal, the mobile terminal is locked with reference to the lock state stored in the server. Even if the ROM of the mobile terminal is programmed to unlock the mobile terminal, when the mobile terminal is started, the mobile terminal is locked according to the lock state stored in the server, avoiding unlocking the mobile terminal through programming the ROM and improving the security of the mobile terminal.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flowchart of a method for locking a mobile terminal according to a first embodiment of the present disclosure.

FIG. 2 is a step flowchart of a method for locking a smart mobile phone according to a second embodiment of the present disclosure.

FIG. 3 is a structural view of a system for locking a mobile terminal according to a third embodiment of the present disclosure.

FIG. 4 schematically illustrates a block diagram of a mobile terminal for executing the method according to the present disclosure.

FIG. 5 schematically illustrates a memory cell for holding or carrying program codes for realizing the method according to the present disclosure.

### DETAILED DESCRIPTION

To clarify the objectives, technical solutions and advantage of the embodiments of the present disclosure, the technical solutions in embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, a person skilled in the art can obtain other embodiments without creative labor, which shall all fall within the protection scope of the present disclosure.

### Embodiment 1

A method for locking a mobile terminal according to the first embodiment of the present disclosure is described in detail. The mobile terminal in this embodiment of the present disclosure can be a smart mobile terminal, for example, a smart mobile phone and a tablet computer.

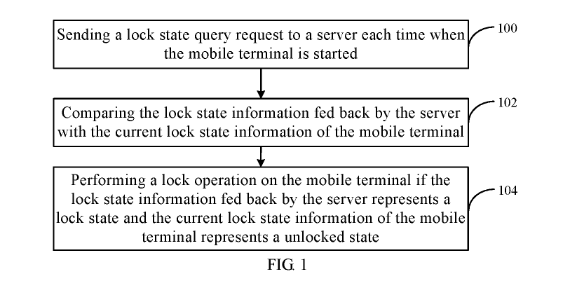

Refer to FIG. 1, which is a step flowchart of a method for locking a smart mobile phone according to the first embodiment of the present disclosure.

Step 100: sending a lock state query request to a server each time when the mobile terminal is started.

Each startup of the mobile terminal includes the startup of the ROM after programming of the mobile terminal. The server stores the lock state information of the mobile terminal. Wherein, the lock state information is used for representing whether the mobile terminal is in the locked state or unlocked state. The server can store the lock state information of at least one mobile terminal; if the server stores the lock state information of a plurality of mobile terminals, then the lock state information and the mobile terminals are in one-to-one correspondence relationship, meaning that a mobile terminal corresponds to a piece of lock state information. The lock state information in the embodiment of the present disclosure can be stored in the server in a character or character string form, for example: “1” represents that the mobile terminal is in the locked state, while “0” represents that the mobile terminal is in the unlocked state.

In an optimal embodiment of the present disclosure, before sending the lock state query request to the server, the mobile terminal is also needed to establish a network connection with the server. Specifically, a network broadcast (CONNECTIVITY_ACTION) monitor is registered to monitor the network connection state of the mobile terminal. After CONNECTIVITY_ACTION is received, it is confirmed that the network connection state is CONNECTED, and then the mobile terminal establishes the network connection with the server.

Step 102: comparing the lock state information fed back by the server with the current lock state information of the mobile terminal.

Whether the mobile terminal in the locked state or in the unlocked state can be represented by the lock state information in the mobile terminal. The representation form is identical with the representation form of the lock state information of the mobile terminal in the server. Through comparing the lock state information fed back by the server with the current lock state information of the mobile terminal, it can be determined that if the lock state of the mobile terminal stored in the server is identical with the current lock state of the mobile terminal.

Step 104: performing a lock operation on the mobile terminal if the lock state information fed back by the server represents a lock state and the current lock state information of the mobile terminal represents an unlocked state.

When the lock state of the mobile terminal stored in the server (remote_lock_state) is different from the current lock state of the mobile terminal (local_lock_state), specifically, when the lock state fed back by the server represents the locked state, and the current lock state of the mobile terminal represents the unlocked state, the current unlocked state of the mobile terminal is changed into the locked state with reference to the lock state of the mobile terminal stored in the server. Specifically, a system user interface (SystemUI) module can be used to perform lock operation on the mobile terminal.

When the lock state information of the mobile terminal stored on the server represents the locked state, the server also stores lock password information of the mobile terminal. When the server stores the lock state information of a plurality of mobile terminals that represents the locked state, the server also stores lock password information corresponding to the plurality of mobile terminals one by one.

In step 104, to perform the lock operation on the mobile terminal, the lock password information acquired from the server can be used to carry out the lock operation.

In conclusion, in the technical solution of the embodiment of the present disclosure, each time when started, the mobile terminal sends the lock state query request to the server which stores the lock state information of the mobile terminal, receives the lock state information fed back by the server, and then compares with the received lock state information with the current lock state information of the mobile terminal. If the received lock state information represents the lock state, the current lock state information of the mobile terminal represents the unlocked state, which means that, when the lock state of the mobile terminal stored in the sever is inconsistent with the current lock state of the mobile terminal, the mobile terminal is locked with reference to the lock state stored in the server. Even if the ROM of the mobile terminal is programmed to unlock the mobile terminal, when the mobile terminal is started, the mobile terminal is locked according to the lock state stored in the server, avoiding unlocking the mobile terminal through programming the ROM and improving the security of the mobile terminal.

### Embodiment 2

A method for locking a mobile terminal according to the second embodiment of the present disclosure is described in detail. The mobile terminal in this embodiment of the present disclosure can be a smart mobile terminal, for example, a smart mobile phone and a tablet computer. The embodiment of the present disclosure is described below by using a smart mobile phone as an example.

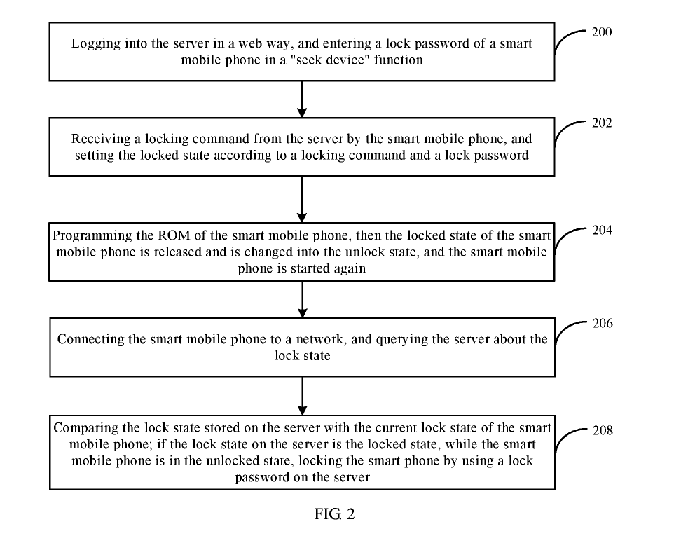

Refer to FIG. 2, which is a step flowchart of a method for locking a smart mobile phone according to the second embodiment of the present disclosure.

Step 200: Logging into the server in a web way, and entering a lock password of a smart mobile phone in a “seek device” function column.

In this embodiment, the smart mobile phone is a smart mobile phone of a user A; if the smart mobile phone is lost, the user A can set the smart mobile phone to be in a locked state on the server in step 200.

Step 202: receiving a locking command from the server by the smart mobile phone, and setting the locked state according to a locking command and a lock password.

Step 204: programming the ROM of the smart mobile phone, then the locked state of the smart mobile phone is released and is changed into the unlock state, and at the time the smart mobile phone is started again.

Through the step 204, the ROM of the smart mobile phone can be programmed by a user B in the event that the smart mobile phone is lost.

Step 206: connecting the smart mobile phone to a network, and querying the server about the lock state.

The network can be a mobile network, for example a network of an operator, or a wireless local network. The embodiment of the present disclosure does not limit the network that the smart mobile phone is connected to, as long as a connection with the server is established.

Step 208: comparing the lock state stored on the server with the current lock state of the smart mobile phone; if the lock state on the server is the locked state, while the smart mobile phone is in the unlocked state, locking the smart phone by using a lock password on the server.

In conclusion, in the technical solution of the embodiment of the present disclosure, each time when started, the mobile terminal sends the lock state query request to the server which stores the lock state information of the mobile terminal, receives the lock state information fed back by the server, and then compares with the received lock state information with the current lock state information of the mobile terminal. If the received lock state information represents the lock state, the current lock state information of the mobile terminal represents the unlocked state, which means that, when the lock state of the mobile terminal stored in the sever is inconsistent with the current lock state of the mobile terminal, the mobile terminal is locked with reference to the lock state stored in the server. Even if the ROM of the mobile terminal is programmed to unlock the mobile terminal, when the mobile terminal is started, the mobile terminal is locked according to the lock state stored in the server, avoiding unlocking the mobile terminal through programming the ROM and improving the security of the mobile terminal.

### Embodiment 3

A system for locking a mobile terminal put forward in the third Embodiment is described in detail.

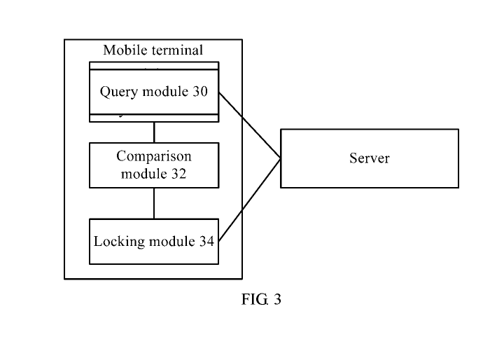

Refer to FIG. 3, which illustrates a structural view of a system for locking a mobile terminal according to the third embodiment of the present disclosure. The system can include a mobile terminal and a server. The mobile terminal in this embodiment of the present disclosure can be a smart mobile terminal, for example, a smart mobile phone and a tablet computer. The server stores the lock state information of the mobile terminal. When the lock state information of the mobile terminal stored on the server represents the locked state, the server also stores lock password information of the mobile terminal.

The mobile terminal can include: a query module 30, a comparison module 32 and a locking module 34.

The functions of each module and the relationships among the modules respectively are described in detail below.

The query module 30 is used for sending a lock state query request to a server each time when the mobile terminal is started.

The comparison module 32 is used for comparing the lock state information fed back by the server with the current lock state information of the mobile terminal.

The locking module 34 is used for performing a lock operation on the mobile terminal if the lock state information fed back by the server represents a lock state and the current lock state information of the mobile terminal represents a unlocked state.

The mobile terminal also includes an acquisition module, used for acquiring the lock password information of the mobile terminal from the server before the locking module 34 performs the lock operation on the mobile terminal.

The locking module 34 uses the lock password information to perform the lock operation on the mobile terminal.

The mobile terminal also includes a connection module, used for establishing a network connection with the mobile terminal before the query module 30 sends the lock state query request to the server.

In conclusion, in the technical solution of the embodiment of the present disclosure, each time when started, the mobile terminal sends the lock state query request to the server which stores the lock state information of the mobile terminal, receives the lock state information fed back by the server, and then compares with the received lock state information with the current lock state information of the mobile terminal. If the received lock state information represents the lock state, the current lock state information of the mobile terminal represents the unlocked state, which means that, when the lock state of the mobile terminal stored in the sever is inconsistent with the current lock state of the mobile terminal, the mobile terminal is locked with reference to the lock state stored in the server. Even if the ROM of the mobile terminal is programmed to unlock the mobile terminal, when the mobile terminal is started, the mobile terminal is locked according to the lock state stored in the server, avoiding unlocking the mobile terminal through programming the ROM and improving the security of the mobile terminal.

The system embodiment described above is schematic, wherein units described as separable parts may be or may be not physically separated, and components displayed as units may be or may be not physical units, which means that the units can be positioned at one place or distributed on a plurality of network units. Some or all modules can be selected to fulfill the objective of the solution in the embodiment upon actual demands. A person skilled in the art can understand and implement the present disclosure without creative work.

Through the description of the above embodiments, a person skilled in the art can clearly know that the embodiments can be implemented by software and necessary universal hardware platforms, or by hardware. Based on this understanding, the above solutions or contributions thereof to the prior art can be reflected in form of software products, and the computer software products can be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

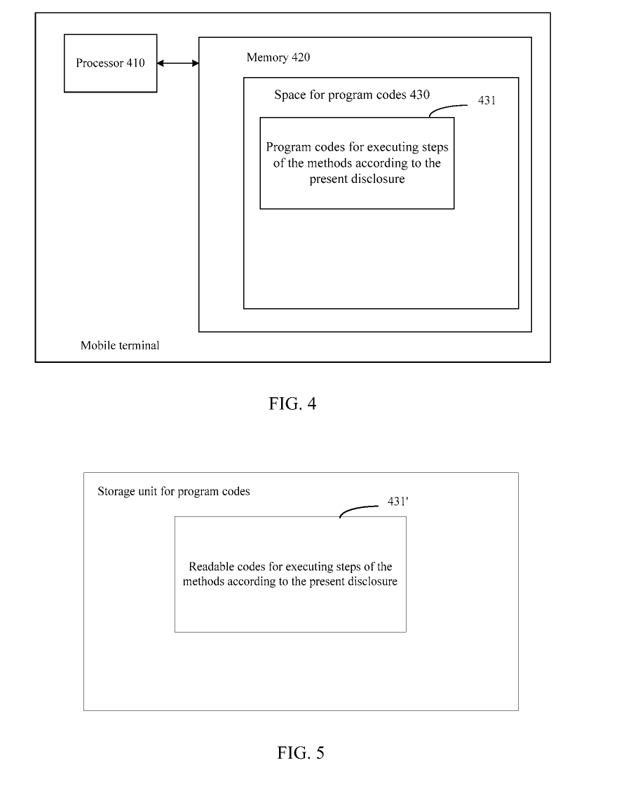

For example, FIG. 4 illustrates a block diagram of a mobile terminal for executing the method according the disclosure. Traditionally, the mobile terminal includes a processor 410 and a computer program product or a computer readable medium in form of a memory 420. The memory 420 could be electronic memories such as flash memory, EEPROM (Electrically Erasable Programmable Read-Only Memory), EPROM, hard disk or ROM. The memory 420 has a memory space 430 for executing program codes 431 of any steps in the above methods. For example, the memory space 430 for program codes may include respective program codes 431 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 5. The memory cells may be provided with memory sections, memory spaces, etc., similar to the memory 420 of the mobile terminal as shown in FIG. 4. The program codes may be compressed for example in an appropriate form. Usually, the memory cell includes computer readable codes 431′ which can be read for example by processors 410. When these codes are operated on the mobile terminal, the mobile terminal may execute respective steps in the method as described above.

Finally, it should be noted that the above embodiments are merely used to describe instead of limiting the technical solution of the present disclosure; although the above embodiments describe the present disclosure in detail, a person skilled in the art shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A method for locking a mobile terminal, applied to a mobile terminal, the method comprising:
sending a lock state query request to a server each time when the mobile terminal is started, wherein the server stores lock state information of the mobile terminal;
comparing the lock state information fed back by the server with the current lock state information of the mobile terminal; and
performing a lock operation on the mobile terminal if the lock state information fed back by the server represents a lock state and the current lock state information of the mobile terminal represents an unlocked state.

2. The method according to claim 1, wherein, when the lock state information of the mobile terminal stored on the server represents the locked state, the server also stores a lock password information of the mobile terminal.

3. The method according to claim 2, wherein, before performing the lock operation on the mobile terminal, the method further comprises:
acquiring the lock password information of the mobile terminal from the server.

4. The method according to claim 3, wherein, the step of performing the lock operation on the mobile terminal comprises:
using the lock password information to perform the lock operation on the mobile terminal.

5. The method according to claim 1, wherein, before sending the lock state query request to the server, the method further comprises:
establishing a network connection with the mobile terminal.

6. A mobile terminal comprising:
at least one processor; and
a memory communicably connected with the at least one processor for storing instructions executable by the at least one processor, wherein execution of the instructions by the at least one processor causes the at least one processor to:
send a lock state query request to a server each time when the mobile terminal is started;
compare the lock state information fed back by the server with the current lock state information of the mobile terminal; and
perform a lock operation on the mobile terminal if the lock state information fed back by the server represents a lock state and the current lock state information of the mobile terminal represents a unlocked state.

7. The mobile terminal according to claim 6, wherein, when the lock state information of the mobile terminal stored on the server represents the locked state, the server further stores a lock password information of the mobile terminal.

8. The mobile terminal according to claim 7, wherein, execution of the instructions by the at least one processor causes the at least one processor to:
acquire the lock password information of the mobile terminal from the server before the lock operation on the mobile terminal is performed.

9. The mobile terminal according to claim 8, wherein, the lock operation on the mobile terminal is performed using the lock password information.

10. The mobile terminal according to claim 6, wherein, execution of the instructions by the at least one processor causes the at least one processor to:
establish a network connection with the mobile terminal before the lock state query request is sent to the server.

11. A non-transitory computer readable medium storing executable instructions that, when executed by a mobile terminal, cause the mobile terminal to:
send a lock state query request to a server each time when the mobile terminal is started;
compare the lock state information fed back by the server with the current lock state information of the mobile terminal; and
perform a lock operation on the mobile terminal if the lock state information fed back by the server represents a lock state and the current lock state information of the mobile terminal represents a unlocked state.

12. The non-transitory computer readable medium according to claim 11, wherein, when the lock state information of the mobile terminal stored on the server represents the locked state, the server further stores a lock password information of the mobile terminal.

13. The non-transitory computer readable medium according to claim 12, wherein, the mobile terminal is further caused to:
acquire the lock password information of the mobile terminal from the server before the lock operation on the mobile terminal is performed.

14. The non-transitory computer readable medium according to claim 13, wherein, the lock operation on the mobile terminal is performed using the lock password information.

15. The non-transitory computer readable medium according to claim 11, wherein, the mobile terminal is further caused to:
establish a network connection with the mobile terminal before the lock state query request is sent to the server.
